(19) United States
(12) Patent Application Publication
(10) Pub. No.: US 2006/0067240 A1
(43) Pub. Date: Mar. 30, 2006

(54) Apparatus and method for detecting network traffic abnormality

(76) Inventors: Hyun Joo Kim, Daejeon-city (KR); Soo Hyung Lee, Daejeon-city (KR); Jin Oh Kim, Daejeon-city (KR); Beom Hwan Chang, Daejeon-city (KR); Jung Chan Na, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/082,031

(22) Filed: Mar. 15, 2005

(30) Foreign Application Priority Data
Sep. 25, 2004 (KR) 10-2004-0077621

(51) Int. Cl. G06F 11/00

(52) U.S. Cl. 370/242

(57) ABSTRACT

An apparatus for detecting a network traffic abnormality includes: a pre-processing unit pre-processing traffics collected from at least one traffic collecting point in a network; a profiler modeling a normal traffic according to a characteristic of the traffic; an analysis model unit generating the thresholds based on the traffic; and an analyzer comparing a relative ratio of the traffic to the entire network traffics and the threshold and determining whether the traffic is abnormal. A combinational use of analysis methods using the relative ratio to the entire traffics and the absolute traffic volume takes into consideration of characteristics of a relative traffic ratio and absolute traffic volume, thereby providing a more reliable determination on whether the traffic is abnormal.

### BACKGROUND OF THE INVENTION

This application claims the priority of Korean Patent Application No. 10-2004-0077621, filed on Sep. 25, 2004, in the Korean Intellectual Property Office, the disclosure of which is incorporated herein in its entirety by reference.

1. Field of the Invention

The present invention relates to network security, and more particularly, to an apparatus and method for detecting a network traffic abnormality by using a relative ratio to the entire traffic to analyze a network traffic and detect a network abnormality in order to more quickly deal with abnormalities such as a network performance degradation, a network paralysis, a network congestion, and the like.

2. Description of the Related Art

Network traffic is conventionally analyzed by collecting information on traffic in a subscriber network link and generating a traffic volume statistics to inform a network manager of the network traffic characteristics. To be more specific, in order to classify and analyze traffic in a terminal connected to a network subscriber and determine a network traffic abnormality, a traffic volume is measured. When the measured traffic volume exceeds a threshold based on the traffic volume established by the network manager, it is determined that a network traffic is abnormal.

However, such traffic analysis makes it difficult to determine an abnormality that may influence the overall network performance, and to establish the threshold suitable for a size of the network since the threshold based on the traffic volume is an absolute value for the traffic volume.

### SUMMARY OF THE INVENTION

The present invention provides an apparatus and method for detecting a network traffic abnormality having flexibility and reliability regardless of a size and characteristic of the network in which a relative ratio to the entire traffic is used to analyze a network traffic by modeling a normal traffic according to a characteristic of the network traffic, and generating thresholds based on a traffic ratio, and a threshold based on the traffic volume is used to verify the abnormality previously determined.

According to an aspect of the present invention, there is provided an apparatus for detecting a network traffic abnormality, comprising: a pre-processing unit pre-processing traffics collected from at least one traffic collecting point in a network; a profiler modeling a normal traffic according to a characteristic of the traffic; an analysis model unit generating more than one threshold based on the characteristic of the traffic; and an analyzer comparing a relative ratio of the traffic among the entire traffics in the network and the threshold and determining whether the traffic is abnormal.

According to another aspect of the present invention, there is provided a method of detecting a network traffic abnormality, comprising: receiving traffics collected at points of a network and modeling a normal traffic according to a characteristic of the traffic; establishing a first threshold using a relative ratio of the traffic among the entire traffics in the network, and a second threshold using an absolute volume of the traffic; comparing data output from the modeling with the first and second thresholds; and if the data exceeds the thresholds, determining it as a network traffic abnormality.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the configuration of a network according to the present invention;

FIG. 2 is a block diagram illustrating an apparatus for detecting a network traffic abnormality according to an embodiment of the present invention; and

FIG. 3 is a flow chart describing a method of detecting a network traffic abnormality according to an embodiment of the present invention.

### DETAILED DESCRIPTION OF THE INVENTION

The above and other features and advantages of the present invention will become more apparent by describing in detail exemplary embodiments thereof with reference to the attached drawings.

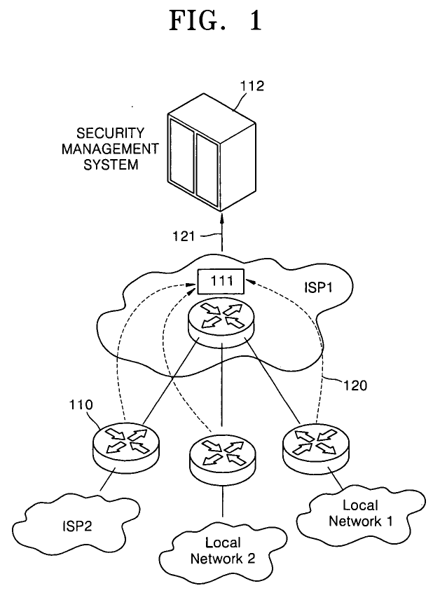

FIG. 1 illustrates the configuration of a network according to the present invention. Referring to FIG. 1, the network for detecting a network traffic abnormality comprises a traffic collector 111 for collecting and combining traffics from points 110 in the network and a security management system 112 for managing the network based on information provided by the traffic collector 111.

The traffic collector 111 periodically collects traffic data 120 from the point 110 in the network, such as a network management agent installed in a network node or a standard equipment for collecting traffics, and combines the collected traffic data 121 and transfers them to the security management system 112. The traffic data is NetFlow data embedded in a Cisco router. The Cisco router provides a NetFlow application to collect information on an Internet packet (IP) in flow units, converts the collected Netflow data into a designated format for transmission thereof. Flow that contains a variety of information on packets such as source, a destination IP address, a destination port number, and a destination protocol number including a starting time is transferred to a collector.

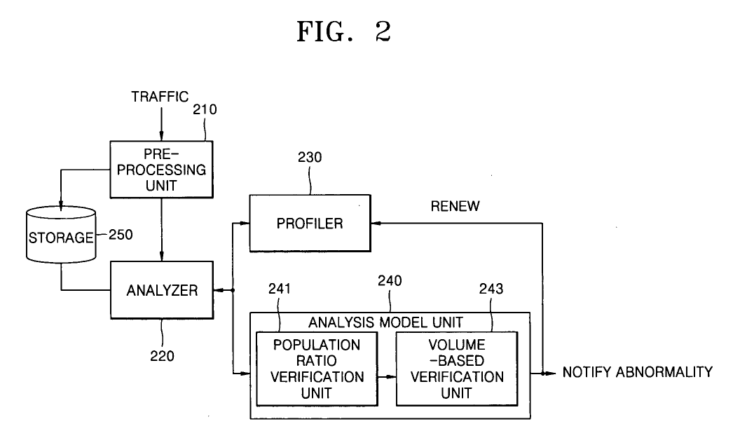

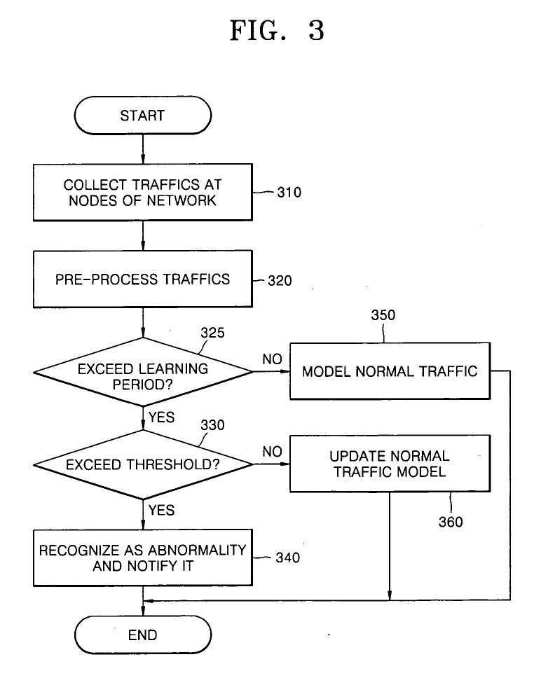

FIG. 2 is a block diagram illustrating an apparatus for detecting a network traffic abnormality according to an embodiment of the present invention. FIG. 3 is a flow chart describing a method of detecting a network traffic abnormality according to an embodiment of the present invention. Referring to FIGS. 2 and 3, the apparatus for detecting a network traffic abnormality is embodied in the security management system 112 shown in FIG. 1. A pre-processing unit 210 pre-processes traffics received by the traffic collector 111 (Operation 310) as information required by an analyzer 220 (Operation 320).

A profiler 230 firstly performs a normal traffic modeling using an average and standard deviation used in a population ratio test method during the traffic learning period (Operation 350) if the traffic learning period is not exceeded (Operation 325). And then the profiler 230 performs a new modeling of the normal traffic during a traffic analysis period. At this time, the analyzer 220 updates information on traffic determined as normal and renews modeling information (Operation 360).

An analysis model unit 240 comprises a population ratio verification unit 241 and a volume-based verification unit 243. The population ratio verification unit 241 generates a mean, standard deviation, and ratio-based threshold by applying a ratio-based analysis model to the traffics pre-processed in the pre-processing unit 210.

The volume-based verification unit 243 generates a volume-based threshold using a statistical test method such as an exponential smoothing model based on an absolute traffic volume.

The analyzer 220 receives the pre-processed data from the pre-processing unit 210 and compares a maximum value, i.e., the ratio-based threshold (referred to as a first threshold in the Claims), of a confidence interval to be calculated by using data generated from the profiler 230 and a present relative ratio of the traffic received from the pre-processing unit 210, and decides that the traffic is abnormal if the present relative ratio of the traffic exceeds the ratio-based threshold.

Then, the analyzer 220 verifies whether the traffic is abnormal using the volume-based threshold (referred to as a second threshold in the Claims) generated in the volume-based verification unit 243 after the verification of abnormality using the ratio-based threshold. The ratio-based threshold and volume-based threshold are consecutively or alternatively used to determine whether the traffic is abnormal (Operation 330).

Alternatively, with respect to determining whether the traffic is abnormal using the relative ratio, if the relative traffic ratio exceeds the ratio-based threshold, this is determined as abnormality, and an abnormality analysis result is notified to a manager (Operation 340).

If the relative traffic ratio does not exceed the ratio-based threshold, this is determined as normality and is reflected on existing normality modeling information for renewal thereof.

Alternatively, with respect to determining whether the traffic is abnormal using the absolute volume, in the same manner as the determining whether the traffic is abnormal using the relative ratio, if the absolute traffic volume exceeds the volume-based threshold, this is determined as abnormality, and an abnormality analysis result is notified to the manager.

If the absolute traffic volume does not exceed the volume-based threshold, this is determined as normality and is reflected on existing normality modeling information, i.e., a mean of traffic volume, for renewal thereof.

When the two verification methods are used together, if results according to each method are different, a reliability level is notified to the manager (Operation 360).

A storage 250 stores analysis results such as information on normality and abnormality generated in each analysis period, and traffic information on a traffic volume or traffic ratio according to a variety of parameters.

Abnormality analysis data is used to manage a network in combination with a security response policy, thereby providing an automatic detection and response.

It is possible for the method for detecting a network traffic abnormality to be realized on a computer-readable recording medium as a computer-readable code. Computer-readable recording mediums include every kind of recording device that stores computer system-readable data. ROMs, RAMs, CD-ROMs, magnetic tapes, floppy discs, flash memory, optical data storage, etc. are used as a computer-readable recording medium. Computer-readable recording mediums can also be realized in the form of a carrier wave (e.g., transmission through Internet). A computer-readable recording medium is dispersed in a network-connecting computer system, resulting in being stored and executed as a computer-readable code by a dispersion method. It is possible for the font ROM data structure according to the present invention to be realized on a computer-readable recording medium as a computer-readable code such as ROMs, RAMs, CD-ROMs, magnetic tapes, floppy discs, flash memory, optical data storage, etc.

As described above, the present invention integrated and analysed the traffics of not the private network but all managed networks, thereby more quickly detecting abnormalities such as a network performance degradation, a traffic congestion, etc., during an initial attack to the network.

A combination use of two analysis methods using the relative ratio to the entire traffics and the absolute traffic volume provides a more reliable determination of whether the traffic is abnormal in consideration of characteristics of the relative traffic ratio and absolute traffic volume.

A population ratio test based on the relative traffic ratio is applied to the analysis of the network traffic without the dependence of the network. That is, the analysis method using the relative ratio to the entire traffics can be used with flexibility regardless of a size of the network.

A reliable and quick analysis is used in combination with an automatic response to the abnormality.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for detecting a network traffic abnormality, comprising:
a pre-processing unit pre-processing traffics collected from at least one traffic collecting point in a network;
a profiler modeling a normal traffic according to a characteristic of the traffic;
an analysis model unit generating more than one threshold based on the characteristic of the traffic; and
an analyzer comparing a relative ratio of the traffic among the entire traffics in the network and the threshold and determining whether the traffic is abnormal.

2. The apparatus of claim 1, wherein the profiler models the normal traffic using an average and standard deviation.

3. The apparatus of claim 1, wherein the analysis model unit comprises:
a population ratio verification unit generating a first threshold using a population ratio test method based on the relative ratio of the traffic in the entire traffics; and
a volume-based verification unit generating a second threshold using a statistical model based on an absolute volume of the traffic.

4. The apparatus of claim 1, wherein the analyzer uses the first and second thresholds simultaneously or alternatively.

5. A method of detecting a network traffic abnormality, comprising:
receiving traffics collected at points of a network and modeling a normal traffic according to a characteristic of the traffic;
establishing a first threshold using a relative ratio of the traffic among the entire traffics in the network, and a second threshold using an absolute volume of the traffic;
comparing data output from the modeling with the first and second thresholds ; and
if the data exceeds the thresholds, determining it as a network traffic abnormality.

6. The method of claim 5, wherein the comparing of data alternatively uses the traffic and the first and second thresholds.

7. A computer readable medium having embodied thereon a computer program for executing a method of detecting a network traffic abnormality, wherein the method comprises:
receiving traffics collected at points of a network and modeling a normal traffic according to a characteristic of the traffic;
establishing a first threshold using a relative ratio of the traffic among the entire traffics in the network, and a second threshold using an absolute volume of the traffic;
comparing data output from the modeling with the first and second thresholds; and
if the data exceeds the thresholds, determining it as a network traffic abnormality.
